(19) United States
(12) Patent Application Publication
(10) Pub. No.: US 2026/0320057 A1
(43) Pub. Date: Oct. 15, 2026

(54) SYSTEM FOR CROSS-MODAL DATA QUERYING AND VALIDATION

(71) Applicant: BANK OF AMERICA CORPORATION, Charlotte, NC (US)

(72) Inventors: N Tulasi Bhavani, Hyderabad (IN); Vijaya Jasti, St. Louis, MO (US); Hoda Moradi, Dallas, TX (US); Mahesh Iyengar, Avondale, PA (US); Chetan Singh Naruka, Gurugram (IN); Vinod Maghnani, Gurugram (IN)

(73) Assignee: BANK OF AMERICA CORPORATION, Charlotte, NC (US)

(21) Appl. No.: 19/173,962

(22) Filed: Apr. 9, 2025

(51) Int. Cl. G06F 16/2457; G06F 16/22; G06F 16/2453

(52) U.S. Cl. CPC G06F 16/24575; G06F 16/2237; G06F 16/24535

(57) ABSTRACT

Systems, computer program products, and methods are described herein for cross-modal data querying and validation. A system may be configured to receive, using a data discovery subsystem, a query from a user. The system may further be configured to process the query to identify keywords, entities, and intent, and generate an embedding representation of the query based on the identified components. The system may also be configured to compare the embedding representation of the query with embedding representations of data stored in a plurality of data modalities. Based on the comparison, the system may be configured to retrieve relevant embedding representations of the data. The system may further be configured to retrieve data processing operations from the query, and execute the data processing operations on the retrieved data. Upon execution of the operations, the system may be configured to generate a verified response that reflects the query intent.

### TECHNOLOGICAL FIELD

Example embodiments of the present disclosure relate to multi-modal data discovery, cross-modal representation learning, optimized query execution, and AI-driven validation frameworks to improve data retrieval accuracy and reliability.

### BACKGROUND

Embodiments of the disclosure relate to querying and validating multi-modal data lakes, which store structured, semi-structured, and unstructured data. Existing solutions require technical expertise, relying on SQL queries and subject matter experts (SMEs), leading to inefficiencies. While generative AI has improved natural language querying, concerns about accuracy, misinformation, and bias persist. Conventional search engines lack semantic understanding across data modalities, and existing cross-modal retrieval models face scalability and efficiency challenges. Current AI validation mechanisms are often task-specific and ineffective for verifying AI-generated insights in real-time decision-making. There is a need for a system that enables natural language querying of complex data lakes, enhances AI-generated output reliability, and optimizes query execution for accuracy and efficiency.

Applicant has identified a number of deficiencies and problems associated with existing methods for querying and validating multi-modal data lakes, including reliance on subject matter experts (SMEs), inefficiencies in retrieving relevant information. Many of these identified problems have been solved by developing solutions that are included in embodiments of the present disclosure, many examples of which are described in detail herein.

### BRIEF SUMMARY

Systems, methods, and computer program products are provided for cross-modal data querying and validation.

In one aspect, a system for cross-modal data querying and validation is presented. The system comprising: a data discovery subsystem configured to: receive, from a user, a query; process the query to identify keywords, entities, and intent; generate an embedding representation of the query based on the identified keywords, entities, and intent; compare the embedding representation of the query with embedding representations of data from a plurality of data modalities; and retrieve relevant embedding representations of the data based on comparing the embedding representation of the query with the embedding representations of the data; a query execution subsystem operatively coupled to the data discovery subsystem, wherein the data discovery subsystem is configured to: retrieve, from the query, data processing operations; map the relevant embedding representations of the data to corresponding relevant data; execute the data processing operations on the relevant data; and generate a response based on executing the data processing operations.

In some embodiments, the system further comprises a cross-modal representation subsystem, wherein the cross-modal representation subsystem is configured to: process data from a plurality of data modalities; generate, using modality-specific encoders, embedding representations for the data from the plurality of data modalities; map the embedding representations of the data into a unified embedding space to enable cross-modal similarity-based retrieval; and index the embedding representations of the data in a vector database.

In some embodiments, mapping the embedding representations of the data into the unified embedding space comprises using a first pre-trained large language model (LLM).

In some embodiments, the plurality of data modalities comprises structured, semi-structured, and unstructured data sources.

In some embodiments, the data discovery subsystem is further configured to: determine that the query comprises a plurality of portions; and in response, divide the query into a plurality of sub-queries, wherein each sub-query is associated with a corresponding portion; generate an embedding representation for each sub-query; compare the embedding representation of each sub-query with embedding representations of data from a plurality of data modalities; and retrieve relevant embedding representations of the data for each sub-query based on comparing the embedding representation of the sub-query with the embedding representations of the data.

In some embodiments, the query execution subsystem is further configured to: retrieve, from each sub-query, at least one data processing operation; execute the data processing operations from the sub-queries in parallel to generate corresponding responses for each sub-query; generate a response for each sub-query in response to executing the data processing operations; and aggregate the responses for the sub-queries to generate the response.

In some embodiments, the query execution subsystem is further configured to: identify contextual gaps in the relevant data; and augment the response using real-time external knowledge sources.

In some embodiments, the query execution subsystem is further configured to: determine that the relevant data is incomplete; and infer, using a second pre-trained LLM model, additional information from the relevant data to augment the response, wherein inferring further comprises using logical inference, statistical estimation, and causal relationship analysis.

In some embodiments, the query execution subsystem is further configured to: determine user-specific preferences based on at least prior query history and domain-specific constraints; and re-format the response based on the user-specific preferences.

In some embodiments, the query execution subsystem is further configured to: generate an alternative response by running hypothetical scenarios, comparative insights, and counterfactual analyses based on variations in the relevant data.

In another aspect, a method for cross-modal data querying and validation is presented. The method comprising: receiving, using a data discovery subsystem, a query from a user; processing, using the data discovery subsystem, the query to identify keywords, entities, and intent; generating, using the data discovery subsystem, an embedding representation of the query based on the identified keywords, entities, and intent; comparing, using the data discovery subsystem, the embedding representation of the query with embedding representations of data from a plurality of data modalities; retrieving relevant embedding representations of the data based on comparing the embedding representation of the query with the embedding representations of the data; retrieving, using a query execution subsystem, data processing operations from the query; mapping, using the query execution subsystem the relevant embedding representations of the data to corresponding relevant data; executing, using the query execution subsystem, the data processing operations on the relevant data; and generating, using the query execution subsystem, a response based on executing the data processing operations.

In yet another aspect, a computer program product for cross-modal data querying and validation is presented. The computer program product comprising a non-transitory computer-readable medium comprising code, which when executed, causes a processor to: receive a query from a user; process the query to identify keywords, entities, and intent; generate an embedding representation of the query based on the identified keywords, entities, and intent; compare the embedding representation of the query with embedding representations of data from a plurality of data modalities; retrieve relevant embedding representations of the data based on comparing the embedding representation of the query with the embedding representations of the data; retrieve data processing operations from the query; map the relevant embedding representations of the data to corresponding relevant data; execute the data processing operations on the relevant data; and generate a response based on executing the data processing operations.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for cross-modal data querying and validation, in accordance with an embodiment of the invention;

FIG. 2 illustrates a system architecture 200 for cross-modal data querying and validation, in accordance with an embodiment of the disclosure; and

FIG. 3 illustrates a process flow 300 for cross-modal data querying and validation, in accordance with an embodiment of the disclosure.

### DETAILED DESCRIPTION

### Overview

Existing systems for querying and validating multi-modal data lakes require extensive manual intervention, reliance on subject matter experts (SMEs), and proficiency in structured query languages (SQL). These constraints create bottlenecks in data retrieval, increase processing time, and reduce system efficiency. Additionally, while generative AI enables natural language-based queries, it lacks accuracy, reliability, and explainability, leading to misinformation, erroneous analytics, and increased computational overhead for error correction. Conventional retrieval systems are further limited by their inability to efficiently integrate and verify AI-generated insights across structured, semi-structured, and unstructured data sources.

Embodiments of the invention provide a real-time data integration, validation, and decision-making system that enables users to query multi-modal data lakes using natural language without requiring technical expertise or prior data integration. The system incorporates a data discovery subsystem, a cross-modal representation subsystem, a query execution subsystem, and a validation subsystem. The data discovery subsystem enables efficient retrieval of relevant data from structured, semi-structured, and unstructured sources by transforming natural language queries into a format that can be matched against multi-modal datasets. The cross-modal representation subsystem encodes data from different modalities into a unified high-dimensional embedding space, allowing the system to retrieve semantically relevant results regardless of data format. The query execution subsystem optimizes query processing by dynamically selecting an execution plan based on computational cost and resource availability, ensuring efficient query execution while maintaining accuracy and performance. The validation subsystem applies a multi-layered verification framework to AI-generated outputs, improving reliability by cross-referencing retrieved data against indexed datasets.

Embodiments of the invention significantly improve the efficiency, accuracy, and scalability of querying and validating multi-modal data lakes. By integrating the data discovery subsystem, cross-modal representation subsystem, query execution subsystem, and validation subsystem, the system enables users to retrieve and verify relevant information from structured, semi-structured, and unstructured data sources without requiring technical expertise or prior data integration. The system automates the transformation of natural language queries into semantically meaningful representations, ensuring precise and efficient data retrieval. Through cross-modal representation learning, the system encodes diverse data types into a unified high-dimensional embedding space, enabling seamless retrieval across different formats. The query execution subsystem dynamically determines the most efficient execution strategy, balancing computational cost and accuracy while optimizing system performance. Additionally, the validation subsystem ensures the reliability of AI-generated outputs through a multi-layered verification framework, cross-referencing retrieved data against indexed datasets to reduce misinformation and erroneous analytics.

The system's ability to optimize resource allocation and streamline query execution allows for adaptability across diverse enterprise data lake architectures. Unlike conventional data retrieval methods that require extensive preprocessing, manual validation, and repetitive computational tasks, the system automates the entire pipeline from query formulation to result verification, conserving computational resources while improving accuracy. The scalable architecture allows seamless integration into various data management frameworks without the need for manual reconfiguration, maintaining broad applicability across industries that rely on multi-modal data analytics, including finance and enterprise intelligence. By significantly improving data retrieval speed, accuracy, and reliability while reducing the computational resources required for manual data extraction and AI validation, the system provides an efficient, automated solution for real-time decision-making in complex, data-driven environments.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

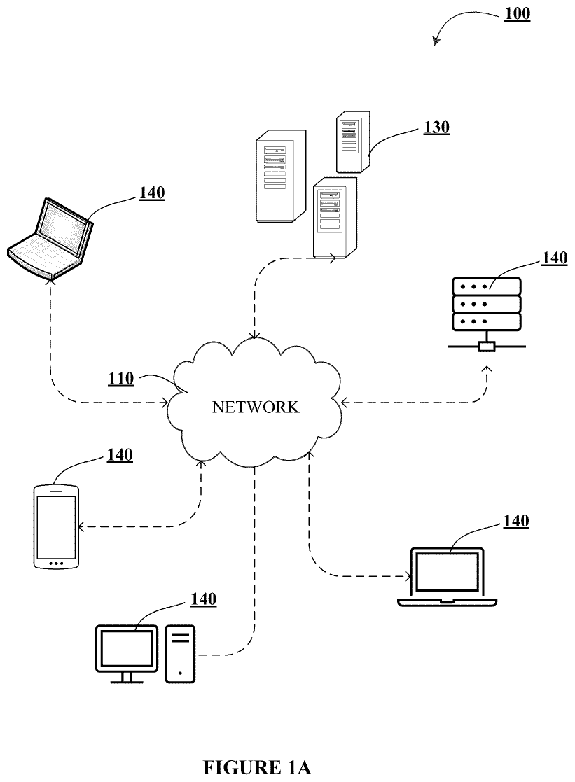

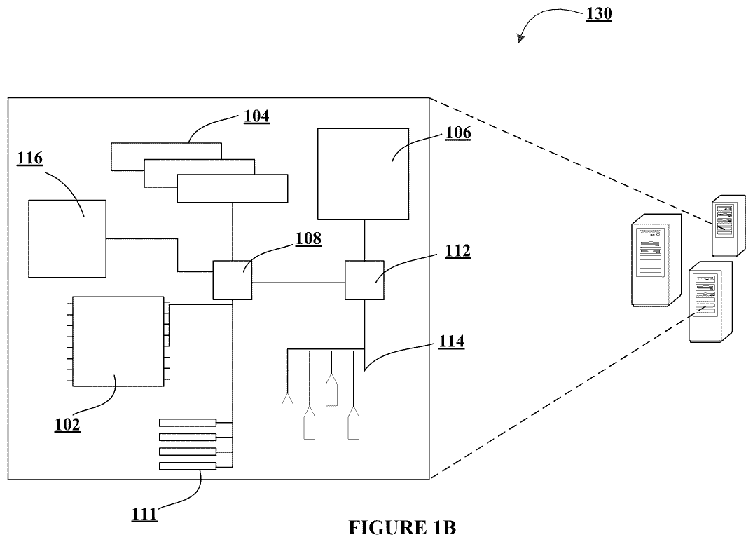

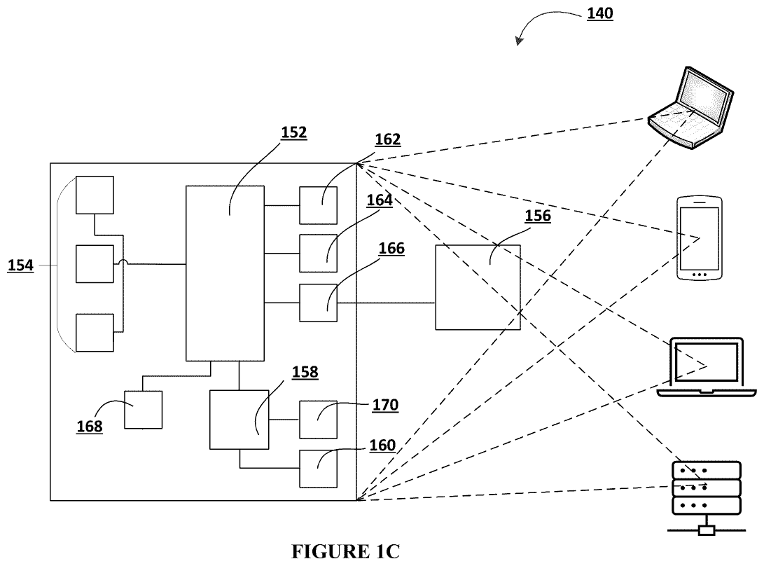

FIGS. 1A-1C illustrate technical components of an exemplary distributed computing environment for cross-modal data querying and validation 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

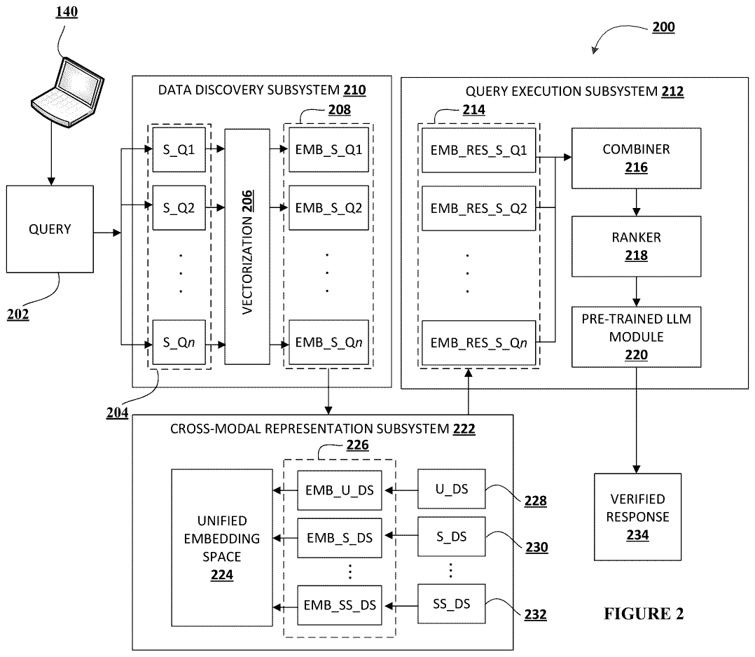

FIG. 2 illustrates a system architecture 200 for cross-modal data querying and validation, in accordance with an embodiment of the disclosure. The system 130 may include a data discovery subsystem 210, a cross-modal representation subsystem 222, and a query execution subsystem 212, each operatively interconnected to facilitate the retrieval, processing, and validation of multi-modal data. The system 130 may be configured to receive a query 202 from an end-point device 140 and process the query to retrieve relevant data embeddings, execute operations on the retrieved data, and generate a response 234.

The data discovery subsystem 210 may be configured to receive a query 202 from a user and determine whether the query comprises multiple portions. In instances in which the query includes multiple portions, the data discovery subsystem 210 may divide the query into sub-queries S_Q1, S_Q2, . . . , S_Qn. The data discovery subsystem 210 may process each sub-query to identify keywords, entities, and intent and subsequently convert each sub-query into an embedding representation EMB_S_Q1, EMB_S_Q2, . . . , EMB_S_Qn through a vectorization process 206. The data discovery subsystem 210 may compare the embedding representation of each sub-query with embedding representations of data stored in the cross-modal representation subsystem 222. The data discovery subsystem 210 may retrieve relevant embedding representations corresponding to each sub-query and transmit the retrieved embedding representations to the query execution subsystem 212 as EMB_RES_S_Q1, EMB_RES_S_Q2, . . . , EMB_RES_S_Qn.

The cross-modal representation subsystem 222 may be configured to process data from multiple data modalities, including structured S_DS 230, semi-structured SS_DS 232, and unstructured U_DS 228 data sources. The cross-modal representation subsystem 222 may generate embedding representations of the data using modality-specific encoders, wherein structured data may be encoded separately from semi-structured and unstructured data. The cross-modal representation subsystem 222 may map the embedding representations EMB_S_DS, EMB_SS_DS, EMB_U_DS into a unified embedding space 224, thereby facilitating cross-modal similarity-based retrieval. The cross-modal representation subsystem 222 may store the embedding representations in an indexed vector database 226 for efficient searching. The cross-modal representation subsystem 222 may utilize a pre-trained LLM model (not shown) to assist in mapping embeddings from different modalities into a common representation.

The query execution subsystem 212 may be configured to retrieve data processing operations associated with each sub-query. The query execution subsystem 212 may execute data processing operations in parallel, wherein each sub-query may generate an intermediate response. The query execution subsystem 212 may include a combiner 216 configured to aggregate responses from multiple sub-queries and a ranking module 218 configured to rank the aggregated responses based on retrieval scores or other relevance measures. The query execution subsystem 212 may further include a pre-trained large language model module 220, which may be configured to refine the response prior to output.

The pre-trained large language model module 220 may be configured to identify contextual gaps in the retrieved data and augment the response using real-time external knowledge sources. The pre-trained large language model module 220 may be further configured to determine whether the retrieved data is incomplete and infer additional information using logical inference, statistical estimation, and causal relationship analysis. The pre-trained large language model module 220 may be configured to reformat the response based on user-specific preferences, wherein such preferences may be determined based on prior query history or domain-specific constraints. The pre-trained large language model module 220 may also be configured to generate alternative responses by running hypothetical scenarios, comparative insights, or counterfactual analyses based on variations in the relevant data.

The system 130 may be configured to output a verified response 234 based on processing performed by the query execution subsystem 212. The verified response 234 may be transmitted to the end-point device 140 from which the query 202 originated. The system architecture illustrated in FIG. 2 may be implemented within a distributed computing environment, wherein various components of the system 130 may be deployed across multiple computing devices. The system 130 may further be configured to interface with external databases, cloud storage systems, or other networked computing environments to retrieve and process relevant data

It will be appreciated that the embodiments described herein are merely examples and that numerous variations, modifications, and adaptations may be made without departing from the scope of the invention. The features and functionalities described may be implemented in different combinations, reconfigurations, or alternative implementations based on system requirements, technological advancements, or design preferences. The descriptions provided herein are not intended to limit the scope of the invention but rather to provide illustrative examples of possible implementations. Any references to specific hardware, software, algorithms, or processing techniques are exemplary and do not preclude the use of alternative approaches that achieve similar functionality.

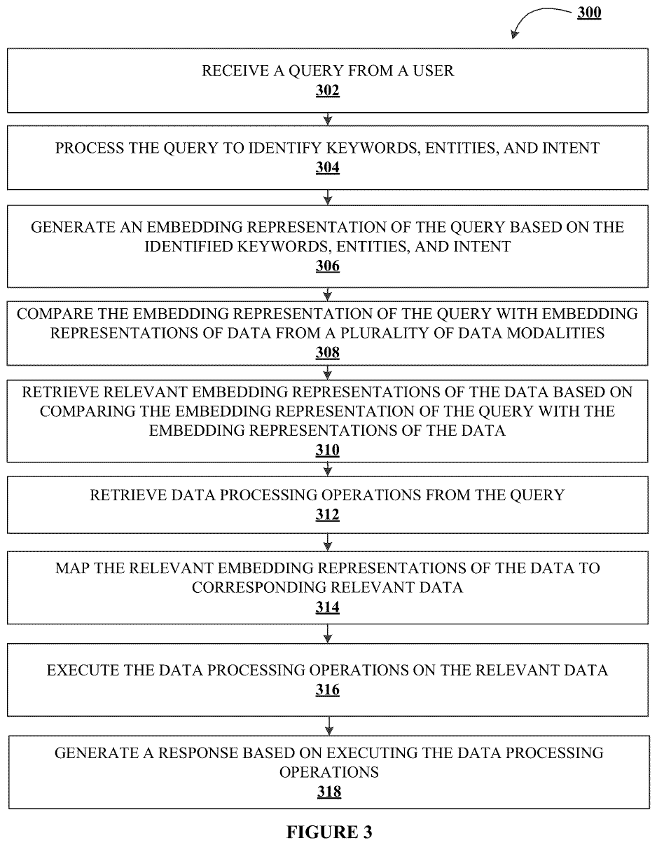

FIG. 3 illustrates a process flow 300 for cross-modal data querying and validation, in accordance with an embodiment of the disclosure. As shown in block 302, the process flow includes receiving, using a data discovery subsystem 210, a query (e.g., query 202) from a user. The query may be received via an end-point device (e.g., end-point device 140), which may include various computing devices such as desktops, laptops, smartphones, or other network-connected interfaces. The data discovery subsystem 210 may be operatively coupled to a networked environment, wherein the received query may be transmitted over a distributed computing architecture that supports multi-modal data retrieval.

In some embodiments, the query may be in natural language form and may include a request for retrieving information, performing analytical operations, or generating insights across structured, semi-structured, and unstructured data sources. The data discovery subsystem 210 may be configured to interpret user intent, enabling seamless query execution without requiring users to manually specify data schemas, sources, or predefined SQL-based queries. The query may include multiple components, such as conditional parameters, categorical constraints, or references to specific data attributes.

In an alternative embodiment, the query 202 may include multiple portions, each corresponding to different data processing requirements. In such cases, the data discovery subsystem 210 may determine that the query comprises sub-queries (e.g., S_Q1, S_Q2, . . . , S_Qn), wherein each sub-query may correspond to a specific retrieval or processing task. The process of query segmentation may be performed dynamically, allowing adaptive decomposition based on query complexity, data availability, or execution constraints.

As shown in block 304, the process flow includes processing, using the data discovery subsystem 210, the query to identify keywords, entities, and intent. The data discovery subsystem 210 may implement natural language processing (NLP) techniques to extract relevant components from the query. These techniques may include tokenization, part-of-speech tagging, named entity recognition (NER), dependency parsing, and semantic role labeling, among others.

The intent of the query may be determined using machine learning models trained on various query structures. For example, the system may classify the query as a retrieval query, aggregation request, comparison query, or analytical computation request. Identifying query intent may allow the system to determine the optimal processing workflow and execution strategy.

The keywords and entities extracted from the query may be mapped to a knowledge graph, schema metadata, or database dictionaries to resolve ambiguities and standardize query parameters. In some embodiments, synonym expansion or contextual disambiguation may be performed using a pre-trained LLM to refine query interpretation. In an alternative embodiment, the query processing step may involve user-specific adaptations, wherein query interpretation is influenced by prior query history, domain-specific constraints, or user preferences. This allows for adaptive query refinement, optimizing response accuracy based on contextual relevance.

As shown in block 306, the process flow includes generating, using the data discovery subsystem 210, an embedding representation of the query based on the identified keywords, entities, and intent. The data discovery subsystem 210 may employ a vectorization process 206 to transform the query into a numerical embedding that captures its semantic meaning. The embedding representation may be generated using pre-trained Transformer-based models, such as BERT, Sentence-BERT, or a domain-specific LLM. The system may convert the query into a high-dimensional vector representation, where similar queries are mapped closer together in the embedding space.

In some embodiments, if the query was divided into multiple sub-queries S_Q1, S_Q2, . . . , S_Qn, a corresponding embedding EMB_S_Q1, EMB_S_Q2, . . . , EMB_S_On may be generated for each sub-query. The embedding representation of each sub-query may be computed separately to allow for parallel processing in later execution stages, as described in further detail in FIG. 5.

In an alternative embodiment, query embeddings may be augmented using external contextual knowledge, such as historical data trends, domain-specific ontologies, or additional data sources. This augmentation may improve query understanding and retrieval accuracy. The embedding representations may also incorporate query-specific weighting factors, allowing the system to prioritize certain aspects of the query over others.

As shown in block 308, the process flow includes comparing, using the data discovery subsystem 210, the embedding representation of the query with embedding representations of data from a plurality of data modalities. The cross-modal representation subsystem 222 may store precomputed embedding representations of structured, semi-structured, and unstructured data in a unified embedding space 224.

The comparison process may involve cosine similarity, Euclidean distance, or other vector similarity measures to identify the most relevant data entries corresponding to the query embedding. The system may retrieve embeddings from structured datasets S_DS 230, semi-structured datasets SS_DS 232, and unstructured datasets U_DS 228. Each dataset may have its own embedding representation (EMB_S_DS, EMB_SS_DS, EMB_U_DS), which is stored in a vector database 226 for efficient retrieval.

In some embodiments, the cross-modal representation subsystem 222 may include a pre-trained LLM (e.g., first pre-trained LLM) configured to facilitate cross-modal similarity alignment. The LLM may map embeddings from different modalities into a common representation, allowing data of various formats to be retrieved based on semantic meaning rather than exact keyword matches. In an alternative embodiment, the system may apply modality-specific weights to improve retrieval accuracy based on query type. For example, if a query requests numerical insights, embeddings from structured datasets may be prioritized. If the query involves contextual analysis, embeddings from unstructured text-based datasets may be weighted more heavily.

As shown in block 310, the process flow includes retrieving, using the data discovery subsystem 210, relevant embedding representations of the data based on the comparison between the query embedding representation and embedding representations stored in the unified embedding space 224 of the cross-modal representation subsystem 222.

The retrieved embeddings may be selected from the unified embedding space 224, where data from structured (S_DS 230), semi-structured (SS_DS 232), and unstructured (U_DS 228) datasets has been previously mapped into a common high-dimensional space. The retrieval process may be based on similarity ranking, using measures such as cosine similarity, dot product similarity, or k-nearest neighbor (k-NN) search to identify the most relevant embeddings. The retrieved embeddings, EMB_RES_S_Q1, EMB_RES_S_Q2, . . . , EMB_RES_S_Qn, may correspond to sub-query embeddings EMB_S_Q1, EMB_S_Q2, . . . , EMB_S_Qn, ensuring that multi-part queries retrieve data from appropriate sources.

The retrieved embeddings may retain cross-modal alignment, allowing data from different modalities to be retrieved together based on semantic relevance rather than direct schema matching. Because the cross-modal representation subsystem 222 maps all data embeddings into the same space, retrieval does not depend on predefined database schemas, enabling flexible and adaptive querying across diverse data formats.

In some embodiments, the retrieval process may include confidence-based ranking to ensure that embeddings with the highest contextual alignment to the query are prioritized. The system may also apply additional filtering or metadata-based constraints to refine the set of retrieved embeddings before forwarding them to the query execution subsystem 212.

In an alternative embodiment, the data discovery subsystem 210 may retrieve embeddings from external knowledge sources in addition to the unified embedding space 224, allowing for augmented retrieval where supplemental information from knowledge graphs or external data repositories may be incorporated to enrich query responses.

As shown in block 312, the process flow includes retrieving, using the query execution subsystem 212, data processing operations from the query 202. The query execution subsystem 212 may analyze the structure of the query to determine specific processing steps, such as aggregation, filtering, sorting, statistical computations, or transformation functions that need to be applied to the retrieved data. If the query was previously divided into sub-queries S_Q1, S_Q2, . . . , S_Qn, the query execution subsystem 212 may retrieve processing operations specific to each sub-query. Each sub-query may correspond to a distinct computational requirement, such as extracting time-series data from structured sources, summarizing textual documents from unstructured sources, or merging data from heterogeneous modalities.

In some embodiments, the retrieved processing operations may be dynamically determined based on query intent, which was previously identified by the data discovery subsystem 210. For example, if the query requires trend analysis, the query execution subsystem 212 may retrieve operations for time-series aggregation. If the query involves comparison of datasets, the query execution subsystem 212 may retrieve processing functions for correlation analysis or feature matching.

In an alternative embodiment, query execution rules may be adaptively selected based on real-time system constraints, such as available computational resources, database load balancing, or query complexity optimizations. The query execution subsystem 212 may modify processing operations dynamically to optimize query execution efficiency while ensuring result accuracy and completeness.

As shown in block 314, the process flow includes mapping, using the query execution subsystem 212, the relevant embedding representations retrieved from the unified embedding space 224 to their corresponding relevant data records. Since the retrieved embeddings EMB_RES_S_Q1, EMB_RES_S_Q2, . . . , EMB_RES_S_Qn do not directly contain raw data but instead represent semantically relevant matches, the query execution subsystem 212 may resolve these embeddings back to their original data formats.

The mapping process may involve referencing an embedding-to-data index stored within the cross-modal representation subsystem 222. This index may associate each embedding with its original data source, allowing the system to reconstruct structured data tables, semi-structured records, and unstructured text documents that correspond to the retrieved embeddings. The mapped data may include structured numerical values, categorical metadata, textual excerpts, images, or other heterogeneous content, depending on the modality of the retrieved embeddings.

In some embodiments, the query execution subsystem 212 may apply multi-modal fusion techniques to align retrieved data from different sources. If an embedding maps to multiple data records across structured and unstructured sources, the system may perform data normalization, schema alignment, or entity linking to integrate information into a coherent representation before further processing.

In an alternative embodiment, the query execution subsystem 212 may apply confidence-based filtering when mapping embeddings to data. If multiple records correspond to a single embedding, the system may prioritize those with higher retrieval scores, more recent timestamps, or greater contextual relevance based on query intent.

As shown in block 316, the process flow includes executing, using the query execution subsystem 212, the data processing operations on the relevant data that was mapped from the retrieved embedding representations. The execution of these operations may involve performing transformations, computations, or analytical functions based on the intent of the original query 202.

The query execution subsystem 212 may apply different types of data processing operations, depending on the structure of the retrieved data. If the query requested statistical computations, the system may execute aggregation functions, trend analysis, or correlation detection. If the query required comparative insights, the system may perform data alignment, feature matching, or cross-referencing across multiple sources. If the query involved natural language data, the system may apply text summarization, entity extraction, or sentiment analysis.

If the query 202 was previously divided into multiple sub-queries S_Q1, S_Q2, . . . , S_Qn, the query execution subsystem 212 may execute the data processing operations for each sub-query in parallel. Each sub-query may operate on a different subset of data, ensuring that computational tasks are distributed efficiently. The system may utilize parallel computing frameworks to execute multiple operations simultaneously, reducing processing latency.

In some embodiments, the query execution subsystem 212 may utilize a pre-trained LLM (e.g., pre-trained LLM 220) to enhance the execution of processing operations on unstructured data. The LLM 220 may assist in semantic reasoning, context inference, or generating structured responses from unstructured text sources.

In an alternative embodiment, the query execution subsystem 212 may dynamically adjust processing operations based on system constraints. If computational resources are limited, the system may prioritize operations with lower complexity or defer non essential computations to optimize execution efficiency.

As shown in block 318, the process flow includes generating, using the query execution subsystem 212, a response 234 based on executing the data processing operations on the relevant data. The query execution subsystem 212 may construct the response by aggregating, formatting, and structuring the processed results. If the retrieved data originated from structured sources, the response may be generated in the form of tables, numerical summaries, or statistical outputs. If the data was derived from semi-structured or unstructured sources, the response may include textual summaries, ranked lists, or annotated excerpts.

As described herein, the query execution subsystem 212 may include a pre-trained LLM, which may be configured to refine the response before output. The LLM may perform response validation, coherence checking, and contextual augmentation to improve result accuracy. In cases where contextual gaps are detected in the retrieved data, the query execution subsystem 212 may augment the response using real-time external knowledge sources, ensuring that missing or incomplete information is supplemented.

In some embodiments, the query execution subsystem 212 may determine that the retrieved data is incomplete and apply logical inference, statistical estimation, or causal relationship analysis to generate inferred responses. This process may allow the system to provide predictive insights or estimated values when exact data points are unavailable.

The query execution subsystem 212 may further refine the response based on user-specific preferences, wherein response formatting or content selection is influenced by prior query history or domain-specific constraints. If multiple response formats are applicable, the system may generate alternative responses by running hypothetical scenarios, comparative insights, or counterfactual analyses based on variations in the retrieved data.

In some embodiments, the response may be verified, using the query execution subsystem 212, the response 234 before transmission to the endpoint device 140. The verification process may include, among other options, cross-referencing retrieved data, ranking responses based on confidence scoring, validating consistency using a pre-trained LLM, augmenting incomplete results with external knowledge sources, and refining the response through an iterative verification loop.

The query execution subsystem 212 may first cross-reference retrieved data against indexed sources within the cross-modal representation subsystem 222 to ensure that retrieved embeddings correspond to accurate, relevant, and non-contradictory data. If the query involved multi-modal data retrieval, the system may verify that structured, semi-structured, and unstructured datasets align with one another.

The query execution subsystem 212 may assign confidence scores (rank) to retrieved responses based on retrieval similarity, source reliability, and semantic relevance. Data with higher confidence scores may be prioritized, while responses with lower confidence scores may be flagged for further refinement or discarded. The system may apply domain-specific thresholds to filter out ambiguous, inconsistent, or low-quality results before response generation.

The pre-trained LLM 220 may analyze the semantic coherence and factual accuracy of the response. The LLM may detect logical contradictions, redundant information, and incomplete statements by comparing structured and unstructured data sources. If inconsistencies are detected, the system may either re-rank the retrieved data or modify the response to improve contextual consistency. The LLM 220 may further refine unstructured text responses by ensuring that natural language generation follows logical flow and aligns with the retrieved evidence.

If the query execution subsystem 212 determines that the retrieved data is incomplete, the system may invoke external knowledge sources, APIs, or real-time databases to supplement missing information. The system may retrieve additional structured facts, contextual metadata, or supporting documentation to enhance response completeness. This augmentation process may prevent information gaps from impacting the accuracy of the response 234.

The system may also perform user-specific validation by adapting the response based on prior query history, domain-specific constraints, or user preferences. The query execution subsystem 212 may restructure the response to align with formatting preferences, terminology, or prior context used in previous interactions.

Before finalizing the response, the system may initiate a multi-step refinement process in which the query execution subsystem 212 iteratively validates, restructures, and improves the response. This iterative loop may include syntactic corrections, redundancy removal, and fact-checking against authoritative sources.

Once the query execution subsystem 212 determines that the response meets accuracy, completeness, and relevance criteria, the verified response 234 may be transmitted to the endpoint device 140.

The process flow described in blocks 302-318 provides a detailed sequence for cross-modal data querying and validation, integrating multi-modal retrieval, embedding-based similarity matching, query execution, and response generation. The system architecture enables efficient, context-aware query processing, leveraging a cross-modal representation subsystem 222, a query execution subsystem 212, and a data discovery subsystem 210 to facilitate seamless querying across structured, semi-structured, and unstructured data sources.

In some embodiments, the system may operate in a distributed computing environment, where multiple instances of the query execution subsystem 212 or cross-modal representation subsystem 222 may function across different computing nodes to optimize scalability and performance. The system may incorporate parallel execution strategies, wherein query decomposition, embedding retrieval, and response generation are handled asynchronously to reduce processing time.

The pre-trained large LLM 220 incorporated in the query execution subsystem 212 may provide advanced inference capabilities, allowing the system to fill contextual gaps, infer missing information, and generate enriched responses. The LLM 220 may apply adaptive reasoning models to refine retrieval accuracy and contextualize results based on domain-specific constraints.

In an alternative embodiment, the system may be configured to interface with external APIs, real-time data feeds, or cloud-based analytical platforms, enabling dynamic augmentation of query responses. The system may adapt its retrieval and processing strategies based on user intent, query complexity, or computing resource availability.

The output of the process flow is a verified response 234, which may be formatted according to user preferences, structured data requirements, or analytical insights. The system may be deployed in enterprise environments, research applications, or large-scale data analytics platforms, allowing users to interact with heterogeneous datasets without requiring schema-specific knowledge or predefined integration steps.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for cross-modal data querying and validation, the system comprising:
a processor; and
a non-transitory storage media storing instructions that, when executed by the processor, cause the processor to:
receive, from a user, a query;
process, via a data discovery subsystem, the query to identify keywords, entities, and intent;
generate, via the data discovery subsystem, an embedding representation of the query based on the identified keywords, entities, and intent;
compare, via the data discovery subsystem, the embedding representation of the query with embedding representations of data from a plurality of data modalities; and
retrieve relevant embedding representations of the data based on comparing the embedding representation of the query with the embedding representations of the data;
retrieve, from the query, data processing operations;
map, via a query execution subsystem associated with the data discovery subsystem, the relevant embedding representations of the data to corresponding relevant data;
execute, via the query execution subsystem, the data processing operations on the relevant data; and
generate, via the query execution subsystem, a response based on executing the data processing operations;
identify, via the query execution subsystem, contextual gaps in the relevant data;
augment, via the query execution subsystem, the response using real-time external knowledge sources;
determine, via the query execution subsystem, that the relevant data is incomplete; and
infer, using a second pre-trained LLM model, additional information from the relevant data to augment the response, wherein inferring further comprises using logical inference, statistical estimation, and causal relationship analysis.

2. The system of claim 1, further comprising a cross-modal representation subsystem, wherein the cross-modal representation subsystem is configured to:
process data from a plurality of data modalities;
generate, using modality-specific encoders, embedding representations for the data from the plurality of data modalities;
map the embedding representations of the data into a unified embedding space to enable cross-modal similarity-based retrieval; and
index the embedding representations of the data in a vector database.

3. The system of claim 2, wherein mapping the embedding representations of the data into the unified embedding space comprises using a first pre-trained large language model (LLM).

4. The system of claim 2, wherein the plurality of data modalities comprises structured, semi-structured, and unstructured data sources.

5. The system of claim 1, wherein the data discovery subsystem is further configured to:
determine that the query comprises a plurality of portions; and
in response, divide the query into a plurality of sub-queries, wherein each sub-query is associated with a corresponding portion;
generate an embedding representation for each sub-query;
compare the embedding representation of each sub-query with embedding representations of data from a plurality of data modalities; and
retrieve relevant embedding representations of the data for each sub-query based on comparing the embedding representation of the sub-query with the embedding representations of the data.

6. The system of claim 2, wherein the query execution subsystem is further configured to:
retrieve, from each sub-query, at least one data processing operation;
execute the data processing operations from the sub-queries in parallel to generate corresponding responses for each sub-query;
generate a response for each sub-query in response to executing the data processing operations; and
aggregate the responses for the sub-queries to generate the response.

7. (canceled)

8. (canceled)

9. The system of claim 1, wherein the query execution subsystem is further configured to:
determine user-specific preferences based on at least prior query history and domain-specific constraints; and
re-format the response based on the user-specific preferences.

10. The system of claim 1, wherein the query execution subsystem is further configured to:
generate an alternative response by running hypothetical scenarios, comparative insights, and counterfactual analyses based on variations in the relevant data.

11. A method for cross-modal data querying and validation, the method comprising:
receiving, using a data discovery subsystem, a query from a user;
processing, using the data discovery subsystem, the query to identify keywords, entities, and intent;
generating, using the data discovery subsystem, an embedding representation of the query based on the identified keywords, entities, and intent;
comparing, using the data discovery subsystem, the embedding representation of the query with embedding representations of data from a plurality of data modalities;
retrieving, using the data discovery subsystem, relevant embedding representations of the data based on comparing the embedding representation of the query with the embedding representations of the data;
retrieving, using a query execution subsystem, data processing operations from the query;
mapping, using the query execution subsystem, the relevant embedding representations of the data to corresponding relevant data;
executing, using the query execution subsystem, the data processing operations on the relevant data;
generating, using the query execution subsystem, a response based on executing the data processing operations;
identifying, using the query execution subsystem, contextual gaps in the relevant data;
augmenting, using the query execution subsystem, the response using real-time external knowledge sources;
determining, using the query execution subsystem, that the relevant data is incomplete; and
inferring, using a second pre-trained LLM model, additional information from the relevant data to augment the response, wherein inferring further comprises using logical inference, statistical estimation, and causal relationship analysis.

12. The method of claim 11, wherein the method further comprises:
processing, using a cross-modal representation subsystem, data from a plurality of data modalities;
generating, using the cross-modal representation subsystem, embedding representations for the data from the plurality of data modalities, wherein generating further comprises using modality-specific encoders;
mapping, using the cross-modal representation subsystem, the embedding representations of the data into a unified embedding space to enable cross-modal similarity-based retrieval; and
indexing, using the cross-modal representation subsystem, the embedding representations of the data in a vector database.

13. The method of claim 12, wherein mapping the embedding representations of the data into the unified embedding space comprises using a first pre-trained large language model (LLM).

14. The method of claim 12, wherein the plurality of data modalities comprises structured, semi-structured, and unstructured data sources.

15. (canceled)

16. A computer program product for cross-modal data querying and validation, the computer program product comprising a non-transitory computer-readable medium comprising code, which when executed, causes a processor to:
receive a query from a user;
process the query to identify keywords, entities, and intent;
generate an embedding representation of the query based on the identified keywords, entities, and intent;
compare the embedding representation of the query with embedding representations of data from a plurality of data modalities;
retrieve relevant embedding representations of the data based on comparing the embedding representation of the query with the embedding representations of the data;
using a query execution subsystem operatively coupled to the data discovery subsystem:
retrieve data processing operations from the query;
map the relevant embedding representations of the data to corresponding relevant data;
execute the data processing operations on the relevant data;
generate a response based on executing the data processing operations;
identify contextual gaps in the relevant data;
augment the response using real-time external knowledge sources;
determine that the relevant data is incomplete; and
infer, using a second pre-trained LLM model, additional information from the relevant data to augment the response, wherein inferring further comprises using logical inference. statistical estimation, and causal relationship analysis.

17. The computer program product of claim 16, wherein the code, when executed, further causes the processor to:
process data from a plurality of data modalities;
generate embedding representations for the data from the plurality of data modalities, wherein generating further comprises using modality-specific encoders;
map the embedding representations of the data into a unified embedding space to enable cross-modal similarity-based retrieval; and
index the embedding representations of the data in a vector database.

18. The computer program product of claim 17, wherein mapping the embedding representations of the data into the unified embedding space comprises using a first pre-trained large language model (LLM).

19. The computer program product of claim 17, wherein the plurality of data modalities comprises structured, semi-structured, and unstructured data sources.

20. (canceled)
